(19) United States
(12) Patent Application Publication
(10) Pub. No.: US 2026/0280694 A1
(43) Pub. Date: Sep. 17, 2026

(54) Methods and Systems to Qualify High Throughput on Fiber ODN Using Fiber Sensing

(71) Applicant: AT&T Intellectual Property I, L.P., Atlanta, GA (US)

(72) Inventors: Bhushan Padhiar, Frisco, TX (US); Stewart Edward Barker, Lucas, TX (US); Lujing Cai, Morganville, NJ (US)

(73) Assignee: AT&T Intellectual Property I, L.P., Atlanta, GA (US)

(21) Appl. No.: 19/081,080

(22) Filed: Mar. 17, 2025

(51) Int. Cl. H04B 10/071

(52) U.S. Cl. CPC H04B 10/071

(57) ABSTRACT

Aspects of the subject disclosure may include, for example, enhancing Passive Optical Networks (PONs) using AI-driven fiber sensing. Optical parameters such as fiber loss and Chromatic Dispersion (CD) are measured using backscattering and feed-forward technologies. A predictive model is trained to correlate these measurements with network performance metrics. This model qualifies Optical Distribution Networks (ODNs) for high-throughput services, optimizing modulation and Forward Error Correction (FEC) schemes, improving network planning and deployment efficiency. Other embodiments are disclosed.

### FIELD OF THE DISCLOSURE

The subject disclosure relates to optical fiber communications.

### BACKGROUND

In the realm of optical fiber communications, Passive Optical Networks (PONs) have emerged as a significant technology for delivering high-speed internet and other broadband services to a vast number of users in an efficient and cost-effective manner. PONs utilize a single optical fiber to serve multiple endpoints, making them an attractive solution for network providers. However, as demand for higher data rates and improved service quality continues to grow, existing PON technologies face challenges in maximizing throughput and maintaining reliability, particularly in point-to-multipoint distribution networks.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for AI-enhanced fiber sensing for optimizing PON network throughput. Other embodiments are described in the subject disclosure.

Passive Optical Networks (PONs) are a pivotal technology in the field of optical fiber communications, enabling the delivery of high-speed internet and broadband services to numerous users through a single optical fiber. This technology is characterized by its use of passive splitters to distribute signals from a central office to multiple endpoints, forming what is known as an Optical Distribution Network (ODN). The ODN is the segment of the network that extends from the data center to the customer premises, and it plays a crucial role in the overall performance and efficiency of PONs. As the demand for higher data rates and improved service quality escalates, there is a growing need to optimize the throughput and reliability of these networks.

Various embodiments described herein leverage advanced fiber sensing technologies, such as Optical Time Domain Reflectometry (OTDR), to gather data on various optical network parameters. These measurements may include fiber loss, Chromatic Dispersion (CD), Polarization Mode Dispersion (PMD), and Polarization Dependent Loss (PDL). By employing both backscattering and feed-forward sensing techniques, the various embodiments can accurately assess the physical state of the optical network. This comprehensive data collection is useful for understanding the network's current conditions and potential limitations.

The gathered data is then used to train a predictive model through machine learning algorithms. This model is designed to correlate the fiber sensing data with high-throughput PON performance metrics, such as modulation order, Bit Error Rate (BER), and Signal-to-Noise Ratio (SNR). By continuously refining the model with real-time monitoring data, the system enhances its predictive accuracy and reliability. This approach allows for the dynamic adaptation of network parameters to optimize performance under varying conditions.

Once trained, the predictive model is applied to qualify ODNs for high-throughput services. By analyzing the sensing data, the model can predict the performance of the network without the need for actual deployment. This capability enables Internet Service Providers (ISPs) to classify and qualify ODNs quickly, ensuring that only those capable of supporting high data rates are deployed. The model also assists in determining optimal network parameters, such as the appropriate modulation scheme and Forward Error Correction (FEC) strategy, to maximize throughput and maintain data integrity.

As described further below, various embodiments provide methods for enhancing the performance of PONs by integrating fiber sensing technologies with machine learning. This approach not only improves network throughput and reliability but also reduces the costs and complexities associated with traditional network testing and deployment. By enabling ISPs to make informed decisions about their optical assets, the system contributes to better network planning, optimization, and service quality.

One or more aspects of the subject disclosure include a device, comprising a processing system including a processor and a memory that stores executable instructions that, when executed by the processing system, facilitate performance of operations. The operations may include sensing at least one first optical network parameter of a first set of optical distribution network (ODNs) to determine first optical network parameter values; measuring at least one first optical network performance metric of the first set of ODNs to determine first optical network performance metric values; training an artificial intelligence (AI) model using the first optical network parameter values and the first optical network performance metric values to develop a predictive model; sensing at least one second optical network parameter of a second ODN to determine second optical network parameter values; providing the second optical network parameter values to the predictive model to generate predicted second optical network performance values; based on the predicted second optical network performance values, determining a modulation scheme to be used in the second ODN, and based on the modulation scheme determined, qualifying the second ODN in terms of its maximum capacity and performance that can be supported.

One or more aspects of the subject disclosure include a non-transitory machine-readable medium, comprising executable instructions that, when executed by a processing system including a processor, facilitate performance of operations. The operations may include performing optical time domain reflectometry (OTDR) to sense multiple optical network parameters of a first optical distribution network (ODN) to obtain a first set of optical network parameter values; evaluating at least one performance metric of the first ODN to obtain first optical network performance metric values; training a machine learning model with the first set of network parameter values and the first optical network performance metric values to create a predictive model; sensing multiple optical network parameters of a second ODN to obtain a second set of optical network parameter values; inputting the second set of optical network parameter values into the predictive model to generate predicted second optical network performance values; and utilizing the predicted second optical network performance values to determine both a modulation scheme and a Forward Error Correction (FEC) scheme to be applied in the second ODN, as well as to qualify the second ODN in terms of its maximum capacity and performance that can be supported.

One or more aspects of the subject disclosure include a method, comprising conducting, by a processing system including a processor, first backscattered light measurements to measure a plurality of optical network parameters of a first optical distribution network (ODN), to obtain a first dataset of optical network parameter values; assessing multiple performance metrics of the first ODN to acquire first optical network performance metric values; developing a predictive model by training a machine learning model with the first dataset of optical network parameter values and the first optical network performance metric values; conducting, by the processing system, second backscattered light measurement to measure a plurality of optical network parameters of a second ODN to obtain a second dataset of optical network parameter values; applying, by the processing system, the second dataset of optical network parameter values to the predictive model to generate predicted second optical network performance values; and utilizing the predictive model to determine, based on the predicted second optical network performance values, a modulation scheme and a Forward Error Correction (FEC) scheme for the second ODN, as well as to qualify the second ODN in terms of its maximum capacity and performance that can be supported.

Additional aspects of the subject disclosure may include determining a Forward Error Correction (FEC) scheme based on the predicted second optical network performance values; wherein the sensing of at least one first optical network parameter comprises performing measurements using optical time domain reflectometry (OTDR); wherein the sensing of at least one first optical network parameter comprises sensing fiber loss, Chromatic Dispersion (CD), Polarization Mode Dispersion (PMD), Polarization Dependent Loss (PDL), or any combination thereof; wherein the sensing of at least one first optical network parameter comprises performing measurements using feed-forward technologies; wherein the measuring of at least one first optical network performance metric comprises measuring modulation order, Bit Error Rate (BER), and Signal-to-Noise Ratio (SNR), or any combination thereof; storing historical optical network parameter values and performance metric values in a database to enhance the accuracy of the predictive model through periodic retraining.

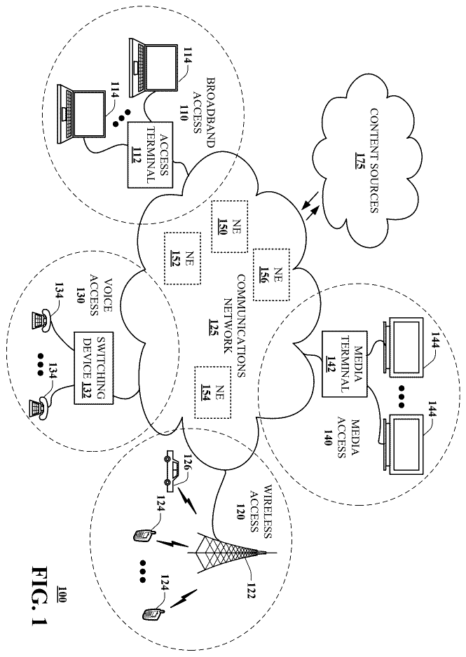

Referring now to FIG. 1, a block diagram is shown illustrating an example, non-limiting embodiment of a system 100 in accordance with various aspects described herein. For example, system 100 can facilitate in whole or in part AI-enhanced fiber sensing for optimizing PON network throughput. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

Various embodiments employ Passive Optical Network (PON) technology to efficiently deliver high-speed internet and broadband services. For example, broadband access 110 may include multiple customer endpoints serviced by a single point in the network, creating a point-to-multipoint Optical Distribution Network (ODN). This setup may utilize passive splitters to distribute signals from communications network 125 to multiple access terminals 112 and/or multiple data terminals 114, incorporating the use of a single optical fiber to serve multiple users.

Incorporating PON technology into the communications network 125 allows for enhanced scalability and cost-effectiveness, particularly in environments where high-speed connectivity is desired. The network elements 150, 152, 154, and 156 facilitate the distribution of content from content sources 175 to various endpoints, such as mobile devices 124 and telephony devices 134, through base stations or access points 122 and switching devices 132, respectively. This integration supports a seamless flow of data across different access types, ensuring reliable and efficient service delivery.

Various embodiments described herein leverage advanced fiber sensing technologies to optimize the performance of such PON-based ODNs. By employing backscattering techniques, such as Optical Time Domain Reflectometry (OTDR), and/or feed-forward technologies, the system can accurately measure critical optical network parameters, including fiber loss, Chromatic Dispersion (CD), Polarization Mode Dispersion (PMD), and Polarization Dependent Loss (PDL). These measurements provide valuable insights into the physical state of the network, enabling precise assessments of its current conditions and potential limitations.

Using the data collected from these measurements, a predictive model is trained through machine learning algorithms. This model correlates the fiber sensing data with network performance metrics, such as modulation order, Bit Error Rate (BER), and Signal-to-Noise Ratio (SNR). Once trained, the predictive model is applied to qualify ODNs for high-throughput services. It predicts network performance without the need for actual deployment, allowing Internet Service Providers (ISPs) to quickly classify and qualify ODNs, ensuring that only those capable of supporting high data rates are deployed.

Various embodiments incorporate flex modulation. Flex modulation refers to a dynamic and adaptive approach to modulation in optical communication networks, particularly in Passive Optical Networks (PONs). It allows the modulation scheme to be adjusted based on the current network conditions and available optical margin. This adaptability helps optimize network throughput and performance by selecting the most efficient modulation format for the given conditions.

In some embodiments, flex modulation is employed to improve the overall efficiency of the network. For example, various embodiments dynamically adjust the modulation scheme to adapt to varying conditions, such as changes in fiber quality, attenuation, and interference. This adaptability ensures that the network maintains high performance even under suboptimal conditions. For example, in some embodiments, flex modulation may be utilized to switch between different modulation schemes, such as Non-Return-to-Zero (NRZ), Pulse Amplitude Modulation (PAM4), Quadrature Phase Shift Keying (QPSK), and higher-order Quadrature Amplitude Modulation (QAM) formats like 16-QAM. The selection of the modulation format is based on factors like signal quality, available bandwidth, and optical signal-to-noise ratio, allowing the network to maximize data throughput.

Furthermore, in some embodiments, flex modulation is used to reduce network congestion and latency, thereby enhancing the quality of service for end-users. By optimizing the modulation scheme, the invention can ensure efficient data transmission, even in the presence of dynamic network conditions. This approach not only boosts network throughput but also contributes to the overall reliability and scalability of the optical network.

In some embodiments, flexible Forward Error Correction (FEC) is utilized to enhance the reliability and efficiency of data transmission in the network. For example, various embodiments adjust the FEC scheme based on the current network conditions and available optical margin, allowing for optimal error correction without unnecessarily consuming bandwidth. For example, various embodiments may employ flexible FEC to select between different error correction codes, depending on factors such as signal quality, bit error rate, and available bandwidth. This adaptability ensures that the network can maintain high data integrity and performance, even under varying conditions.

Furthermore, in some embodiments, flexible FEC may be used to increase the effective bandwidth capacity of the network. By selecting high-throughput FEC schemes when the optical network has sufficient margin, an additional 8-9% of bandwidth capacity may be achieved. Conversely, when the network conditions are less favorable, FEC schemes that provide greater error correction may be employed to ensure data integrity. Also for example, the flex FEC may switch between Reed-Solomon codes and Low-Density Parity-Check (LDPC) codes. Reed-Solomon codes are effective for correcting burst errors, while LDPC codes provide high error correction capability with lower overhead, making them suitable for random errors. In a further example, various embodiments may adjust the code rate of the FEC scheme. A higher code rate, such as 7/8, provides less redundancy and is used when network conditions are favorable, maximizing throughput. Conversely, a lower code rate, such as 1/2, introduces more redundancy, which is beneficial in poor network conditions to ensure data integrity. Furthermore, in some embodiments, the block length of the FEC scheme may be adapted. Shorter block lengths can reduce latency and are suitable for real-time applications, while longer block lengths can provide better error correction performance in environments with high error rates. In yet another example, various embodiments may employ a hybrid FEC approach, combining different FEC techniques to address specific error patterns. For example, a combination of convolutional codes and block codes can be used to enhance error correction capabilities in diverse network conditions.

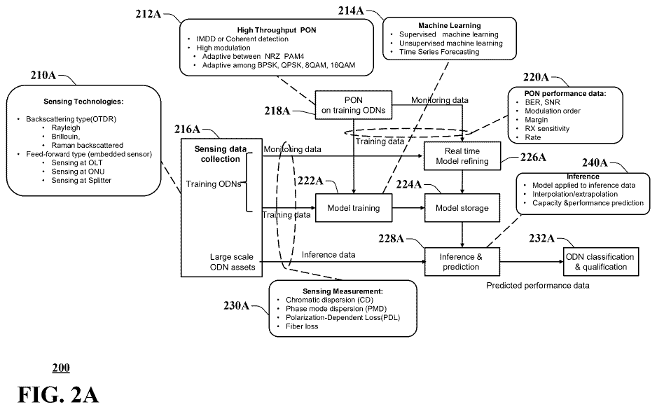

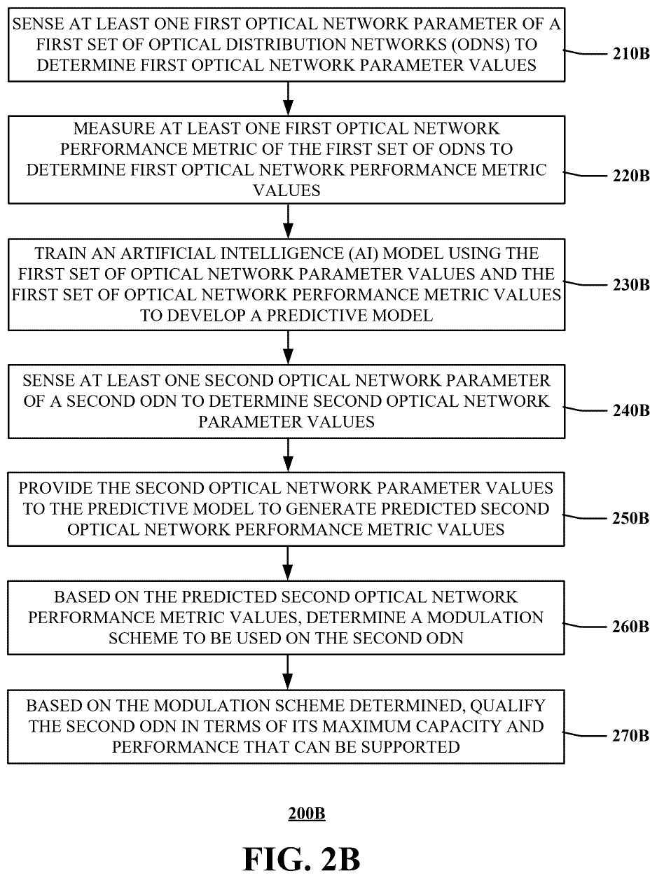

FIG. 2A is a block diagram illustrating an example, non-limiting embodiment of a system functioning within the communication network of FIG. 1 in accordance with various aspects described herein. FIG. 2A illustrates System 200, which embodies the methods and systems for qualifying high throughput on Fiber Optical Distribution Networks (ODNs) using advanced fiber sensing and machine learning techniques. The system comprises several components, each playing a role in optimizing Passive Optical Networks (PONs).

Sensing Technologies 210A is responsible for gathering data from ODNs using backscattering and/or feed-forward sensing methods. Backscattering techniques, such as Optical Time Domain Reflectometry (OTDR), involve sending light pulses down the fiber and analyzing the light that is scattered back to measure parameters like fiber loss, Chromatic Dispersion (CD), Polarization Mode Dispersion (PMD), and Polarization Dependent Loss (PDL). These measurements are useful for assessing the physical state of the network. In contrast, feed-forward technologies incorporate additional sensors directly into ODN endpoints and splitters. These sensors are embedded within the PON devices, such as Optical Line Terminals (OLTs), Optical Network Units (ONUs), or splitters, and are used to measure optical network impairments. This approach allows for smart scanning through parameters without impacting the service, providing comprehensive data collection that supports the qualification of the network for higher throughput.

High throughput PON 212A represents one or more content delivery networks that utilize PON technology. These networks dynamically adjust modulation schemes, such as Non-Return-to-Zero (NRZ), Pulse Amplitude Modulation (PAM4), and Quadrature Phase Shift Keying (QPSK), as well as Forward Error Correction (FEC) strategies, so that network performance measurements can be made to train the predictive model. Some of these content delivery networks may be used for training, while others may be qualified using the results of the training. This adaptability ensures that the network maintains high throughput and reliability.

Sensing data collection 216A operates in two parts: first, it collects training data from the training ODNs, which is used to train the predictive model. Second, it collects sensing data from large-scale ODN assets to qualify these assets. This data serves as input for the predictive model to assess and qualify the large-scale ODNs for high-throughput services.

PON on training ODNs 218A represents the training ODNs being used with different flex modulation and flex FEC schemes as shown at 212A. The performance data at 220A shows the measured performance data of the training ODNs for each combination of the flex modulation and flex FEC scheme. This performance data, along with the sensed data at 216A, is used for model training at 222A.

Model training 222A uses the collected data (e.g., training data provided by sensing data collection 216A and PON on training ODNs 218) to train the machine learning model, creating a predictive model that can forecast network performance under various conditions. Various embodiments may use different learning algorithms as shown at machine learning 214A. Machine learning 214A employs advanced algorithms to create a predictive model that correlates the sensing data with network performance metrics. For example, machine learning 214A may employ supervised learning techniques, unsupervised learning techniques, as well as time series forecasting, to enhance its accuracy and reliability. Model storage 224A ensures that the trained model is securely stored and readily accessible for real-time inference and prediction tasks.

Sensing Measurement 230A represents detailed measurements of optical network parameters, which are important for accurate model predictions. Inference and Prediction 228A involves using the predictive model to make informed decisions about network configuration, ensuring that the network operates at peak efficiency. Inference and Prediction 228A applies the predictive model to new data, to determine capacity and performance prediction as shown at 240A to allow for the dynamic adjustment of network parameters to optimize performance. ODN classification & qualification 232A classifies and qualifies ODNs based on the predicted performance data, enabling network providers to deploy networks capable of supporting high data rates. In some embodiments, ODN classification and qualification 232A includes modulation and FEC schemes that may be supported by the various ODNs. This comprehensive system enhances network planning, optimization, and service quality, contributing to the overall efficiency and reliability of PONs.

Real-time model refining, as represented by 226A in FIG. 2A, operates to enhance the predictive model's accuracy and reliability over time. After the initial training phase, where the model is developed using comprehensive datasets from Sensing Data Collection 216A and PON on Training ODNs 218A, the model enters a continuous refinement phase. This phase leverages ongoing monitoring data to enhance the model's predictive capabilities.

Monitoring data from Sensing Data Collection 216A includes real-time measurements from backscattering and/or feed-forward sensing technologies. These measurements provide up-to-date information on optical network parameters such as fiber loss, Chromatic Dispersion (CD), Polarization Mode Dispersion (PMD), and Polarization Dependent Loss (PDL). This data reflects the current state of the network and any changes that may occur over time.

Simultaneously, monitoring data from PON on Training ODNs 218A captures performance metrics such as modulation order, Bit Error Rate (BER), and Signal-to-Noise Ratio (SNR) under various conditions and configurations. This data is useful for understanding how the network responds to different modulation and Forward Error Correction (FEC) schemes.

By integrating this continuous stream of monitoring data, the model can be refined in real-time to adapt to evolving network conditions. This process involves updating the model's parameters and algorithms to reflect the latest data, ensuring that the model's predictions remain accurate and relevant. The real-time refining process allows the model to dynamically adjust to changes in the network, such as variations in fiber quality or environmental conditions, thereby maintaining optimal network performance.

Regarding model training operations represented by FIG. 2A, the operations used to train the predictive model involve a systematic approach that integrates data from various sources to enhance the model's accuracy and reliability. The process begins with the collection of comprehensive sensing data through Sensing Technologies 210A, which employs backscattering and/or feed-forward methods. Backscattering techniques, such as Optical Time Domain Reflectometry (OTDR), provide measurements of critical optical network parameters like fiber loss, Chromatic Dispersion (CD), Polarization Mode Dispersion (PMD), and Polarization Dependent Loss (PDL). Concurrently, feed-forward technologies incorporate sensors within network components to gather additional data on network impairments. This sensed data is aggregated by Sensing Data Collection 216A, which organizes the information for use in model training.

PON on Training ODNs 218A represents the deployment of training PONs with various flex modulation and flex Forward Error Correction (FEC) schemes, as shown in High Throughput PON 212A. The performance data collected at 220A captures the network's response to these different combinations of modulation and FEC, providing insights into the network's capabilities and limitations.

The combination of sensed data and PON performance data is then used in Model Training 222A. This step involves employing advanced machine learning algorithms to correlate the collected data with network performance metrics, such as modulation order, Bit Error Rate (BER), and Signal-to-Noise Ratio (SNR). In some embodiments, the model is trained using both supervised and unsupervised learning techniques, as well as time series forecasting, to ensure it can accurately predict network performance under various conditions.

This training process is used to train the predictive model which may then be used to qualify the Optical Distribution Network (ODN) for higher throughput by determining the optimal modulation and FEC schemes that the network can support. The trained predictive model enables dynamic adjustments to network parameters, ensuring that the network operates at peak efficiency and reliability. This innovative approach leverages AI/ML-based fiber sensing technology to address challenges in point-to-multipoint fiber distribution networks, ultimately boosting network throughput and improving user services.

Regarding the ODN classification and qualification operations represented by FIG. 2A, the operations for using the predictive model to qualify Optical Distribution Networks (ODNs) involve a series of steps that leverage advanced sensing data and machine learning to optimize network performance. Once the predictive model is trained using the comprehensive dataset from Sensing Data Collection 216A and PON Performance Data 220A, it is applied to assess and qualify ODNs for high-throughput services.

The process begins with the application of the predictive model in Inference and prediction 228A, where the model analyzes new data collected from large-scale ODN assets. This data includes measurements obtained through backscattering and/or feed-forward sensing technologies, which provide detailed insights into the network's current conditions and potential limitations. Inference and Prediction 228A involves using the predictive model to make informed decisions about the network's configuration. The model evaluates the network's ability to support various modulation schemes and Forward Error Correction (FEC) strategies, determining the optimal settings that maximize throughput while maintaining reliability.

As an example of this process is the qualification of an ODN that has a largest point-to-point fiber length of 10 miles, that uses PON technology initially designed to operate out to 20 miles of fiber. The predictive model, based on the sensed measurements, may qualify this network for higher throughput by adjusting the modulation and FEC schemes. The model assesses the network's loss budget and other parameters to determine if it can support increased data rates, potentially increasing throughput by double or more, depending on the network's capabilities.

This approach allows Internet Service Providers (ISPs) to optimize their network assets, ensuring efficient and reliable service delivery. Further, by dynamically qualifying ODNs for higher throughput, the system enhances network planning and optimization, ultimately improving user services and addressing challenges in point-to-multipoint fiber distribution networks.

FIG. 2B depicts an illustrative embodiment of a method in accordance with various aspects described herein. At block 210B, the method 200B involves sensing at least one first optical network parameter of a first set of ODNs (e.g., the training ODNs referred to above) to determine first optical network parameter values. In some embodiments, this action may involve performing measurements using Optical Time Domain Reflectometry (OTDR) to sense parameters such as fiber loss, Chromatic Dispersion (CD), Polarization Mode Dispersion (PMD), and Polarization Dependent Loss (PDL), or any combination thereof. For example, sensors embedded in network devices might perform these measurements to gather comprehensive data on the network's physical state. Additionally, feed-forward technologies may be employed to complement these measurements.

At block 220B, the method includes measuring at least one first optical network performance metric of the first set of ODNs to determine first optical network performance metric values. In some embodiments, this may involve measuring metrics such as modulation order, Bit Error Rate (BER), and Signal-to-Noise Ratio (SNR), or any combination thereof. For example, network monitoring tools could be used to collect performance data that reflects the network's operational efficiency.

At block 230B, the method involves training an artificial intelligence (AI) model using the first optical network parameter values and the first optical network performance metric values to develop a predictive model. In some embodiments, this training process may utilize supervised learning techniques to correlate the data. For example, supervised learning might be employed to enhance the model's predictive accuracy, ensuring it can effectively forecast network performance based on backscattering and/or feed forward measurements.

At block 240B, the method includes sensing at least one second optical network parameter of a second ODN to determine second optical network parameter values. In some embodiments, this action may involve similar sensing operations as block 210B but applied to a different network segment. For example, backscattering or feed-forward technologies might be used to gather data from additional sensors embedded in a network that was not used for gathering training data.

At block 250B, the method involves providing the second optical network parameter values to the predictive model to generate predicted second optical network performance metric values. In some embodiments, this may involve inputting real-time data into the model for analysis. For example, data integration tools could streamline this process, ensuring seamless data transfer to the model.

At block 260B, the method includes determining a modulation scheme to be used on the second ODN based on the predicted second optical network performance metric values. In some embodiments, this may involve selecting the most efficient modulation format. Additionally, the operations further comprise determining a Forward Error Correction (FEC) scheme based on the predicted second optical network performance values to optimize network throughput and reliability.

At block 270B, the method includes qualifying the second ODN in terms of its maximum capacity and performance that can be supported based on the predicted second optical network performance metric values and/or the modulation scheme and FEC scheme determined at 260B.

In the context of qualifying an ODN, various embodiments may balance capacity and quality based on an intended use or desired performance characteristic. For example, various embodiments may determine whether to maximize capacity at a given quality level or to enhance quality at a specified capacity. As described above with reference to block 270B, various embodiments may encompass two predictive aspects: achieving maximum capacity while maintaining a certain quality, or optimizing quality for a predetermined capacity. The AI model can assist in this process by identifying an optimal modulation format to meet specific performance objectives, which may not always align with the most efficient modulation format for other metrics. These objectives can be dynamic, allowing the AI model to set particular thresholds based on the network's current state. For example, during a high-demand event like a football game in a densely populated area, the system might prioritize throughput over Quality of Service (QoS) to accommodate the increased data traffic. This adaptability can help the network efficiently respond to varying conditions and user demands.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

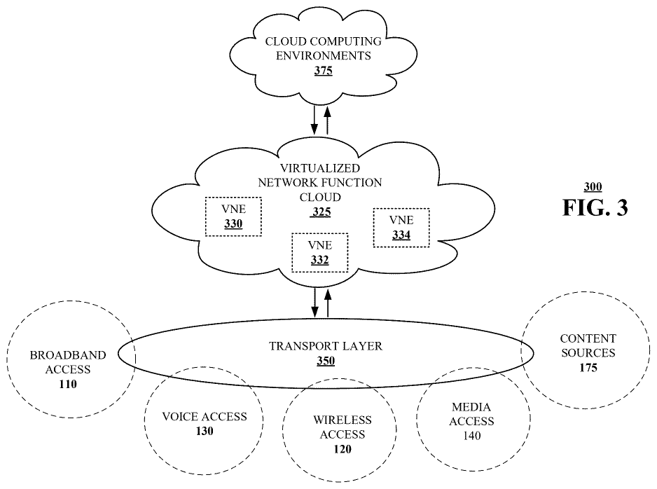

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems, and functions described herein. For example, virtualized communication network 300 can facilitate in whole or in part AI-enhanced fiber sensing for optimizing PON network throughput.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

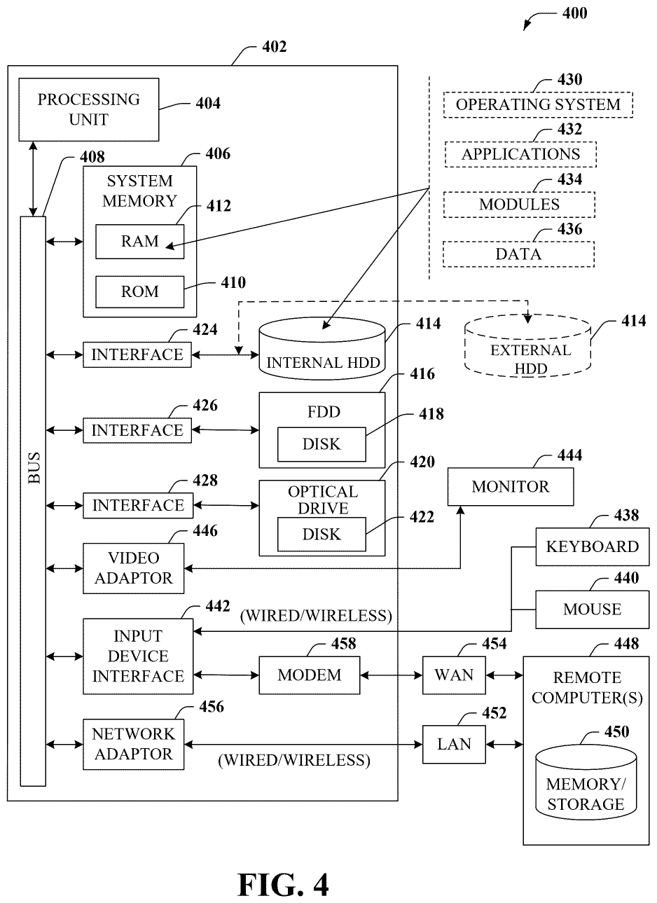

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part AI-enhanced fiber sensing for optimizing PON network throughput.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

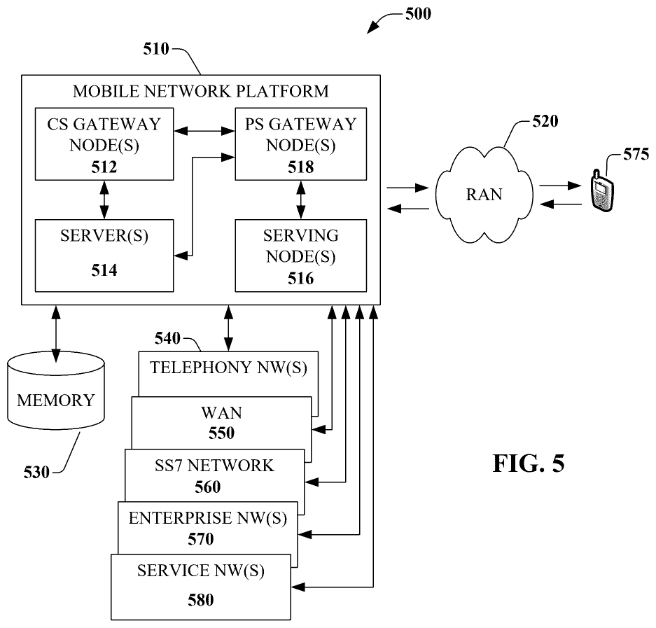

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part AI-enhanced fiber sensing for optimizing PON network throughput. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

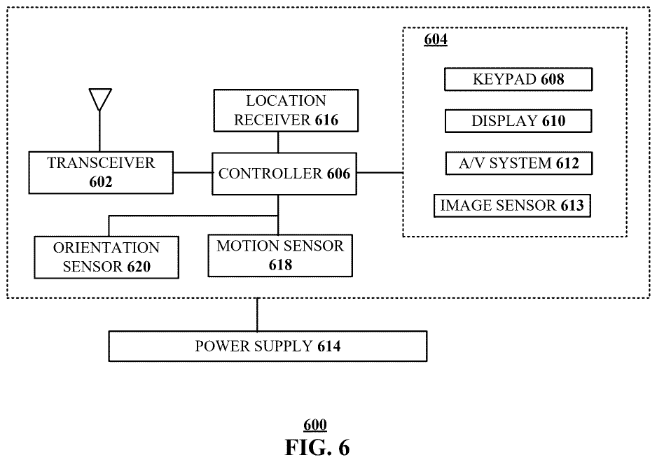

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part AI-enhanced fiber sensing for optimizing PON network throughput.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
sensing at least one first optical network parameter of a first set of optical distribution networks (ODNs) to determine first optical network parameter values;
measuring at least one first optical network performance metric of the first set of ODNs to determine first optical network performance metric values;
training an artificial intelligence (AI) model using the first optical network parameter values and the first optical network performance metric values to develop a predictive model;
sensing at least one second optical network parameter of a second ODN to determine second optical network parameter values;
providing the second optical network parameter values to the predictive model to generate predicted second optical network performance metric values; and
based on the predicted second optical network performance metric values, determining a modulation scheme to be used in the second ODN.

2. The device of claim 1, wherein the operations further comprise determining a Forward Error Correction (FEC) scheme based on the predicted second optical network performance values.

3. The device of claim 1, wherein the sensing the at least one first optical network parameter comprises performing measurements using optical time domain reflectometry (OTDR).

4. The device of claim 1, wherein the sensing the at least one first optical network parameter comprises sensing fiber loss, Chromatic Dispersion (CD), Polarization Mode Dispersion (PMD), Polarization Dependent Loss (PDL), or any combination thereof.

5. The device of claim 1, wherein the sensing the at least one first optical network parameter comprises performing measurements using feed-forward technologies.

6. The device of claim 1, wherein the measuring the at least one first optical network performance metric comprises measuring modulation order, Bit Error Rate (BER), and Signal-to-Noise Ratio (SNR), or any combination thereof.

7. The device of claim 1, wherein the operations further comprise storing historical optical network parameter values and performance metric values in a database to enhance accuracy of the predictive model through periodic retraining.

8. A non-transitory machine-readable medium, comprising executable instructions that, when executed by a processing system including a processor, facilitate performance of operations, the operations comprising:
performing optical time domain reflectometry (OTDR) to sense multiple optical network parameters of a first set of optical distribution networks (ODNs) to obtain a first set of optical network parameter values;
evaluating at least one performance metric of the first set of ODNs to obtain first optical network performance metric values;
training a machine learning model with the first set of network parameter values and the first optical network performance metric values to create a predictive model;
sensing multiple optical network parameters of a second ODN to obtain a second set of optical network parameter values;
inputting the second set of optical network parameter values into the predictive model to generate predicted second optical network performance values; and
utilizing the predicted second optical network performance values to determine both a modulation scheme and a Forward Error Correction (FEC) scheme to be applied in the second ODN.

9. The non-transitory machine-readable medium of claim 8, wherein the optical network parameters include fiber loss, Chromatic Dispersion (CD), Polarization Mode Dispersion (PMD), and Polarization Dependent Loss (PDL).

10. The non-transitory machine-readable medium of claim 8, wherein the first optical network performance metrics include modulation order, Bit Error Rate (BER), and Signal-to-Noise Ratio (SNR).

11. The non-transitory machine-readable medium of claim 8, wherein the machine learning model is trained using supervised learning techniques.

12. The non-transitory machine-readable medium of claim 8, wherein the predictive model is periodically updated with new data to improve its accuracy and reliability.

13. The non-transitory machine-readable medium of claim 8, wherein the modulation scheme is selected from a group comprising Non-Return-to-Zero (NRZ), Pulse Amplitude Modulation (PAM4), and Quadrature Phase Shift Keying (QPSK).

14. The non-transitory machine-readable medium of claim 8, wherein the FEC scheme is selected from a group comprising Reed-Solomon codes and Low-Density Parity-Check (LDPC) codes.

15. The non-transitory machine-readable medium of claim 8, wherein the operations further comprise storing historical optical network parameter values and performance metric values in a database for future analysis and model retraining.

16. A method,
comprising:
conducting, by a processing system including a processor, first backscattered light measurements to measure a first plurality of optical network parameters of a first set of optical distribution networks (ODNs), to obtain a first dataset of optical network parameter values;
assessing, by the processing system, multiple performance metrics of the first set of ODNs to acquire first optical network performance metric values;
developing, by the processing system, a predictive model by training a machine learning model with the first dataset of optical network parameter values and the first optical network performance metric values;
conducting, by the processing system, second backscattered light measurement to measure a second plurality of optical network parameters of a second ODN to obtain a second dataset of optical network parameter values;
applying, by the processing system, the second dataset of optical network parameter values to the predictive model to generate predicted second optical network performance values; and
utilizing, by the processing system, predictive model to determine, based on the predicted second optical network performance values, a modulation scheme and a Forward Error Correction (FEC) scheme for the second ODN.

17. The method of claim 16, wherein the first plurality of optical network parameters include fiber loss, Chromatic Dispersion (CD), Polarization Mode Dispersion (PMD), Polarization Dependent Loss (PDL), or a combination thereof.

18. The method of claim 16, wherein the multiple performance metrics include modulation order, Bit Error Rate (BER), Signal-to-Noise Ratio (SNR), or a combination thereof.

19. The method of claim 16, wherein the machine learning model is trained using supervised learning techniques.

20. The method of claim 16, wherein the predictive model is periodically updated with new data to improve its accuracy and reliability over time.
